(19) United States
(12) Patent Application Publication
(10) Pub. No.: US 2026/0352332 A1
(43) Pub. Date: Nov. 5, 2026

(54) METHOD FOR DETERMINING A SUITABLE LINE SCANNING FREQUENCY AND SYSTEM FOR TRANSMITTING LIGHT

(71) Applicant: SEW-EURODRIVE GMBH & CO. KG, Bruchsal (DE)

(72) Inventors: Josef SCHMIDT, Philippsburg - Huttenheim (DE); Zhidong HUA, Bruchsal (DE); Thomas SCHÄFER, Karlsdorf-Neuthard (DE); Frank Stephan VON SCHOETTLER FRANCESCHI, Karlsruhe (DE)

(73) Assignee: SEW-EURODRIVE GMBH & CO. KG, Bruchsal (DE)

(21) Appl. No.: 19/101,728

(22) PCT Filed: Jul. 18, 2023
(86) PCT No.: PCT/EP2023/069881

§ 371 Date: Feb. 6, 2025

(30) Foreign Application Priority Data
Aug. 10, 2022 (DE) 10 2022 002 898.0

(51) Int. Cl. H04B 10/116; H04B 10/69; H04N 17/00; H04N 23/55

(52) U.S. Cl. CPC H04B 10/116; H04B 10/697; H04N 17/00; H04N 23/55

(57) ABSTRACT

A method for determining a suitable line scanning frequency of a receiver when receiving a light signal transmitted by a transmitter includes: capturing a number of images of the light signal at the line fundamental frequency; selecting a column from each of the captured images; assembling the selected columns in order to form a matrix; determining a point of maximum light intensity in each line of the matrix; determining a point of minimum light intensity in each line of the matrix; selecting a column of the matrix, in which for each point of the selected column: determining an upper deviation of the light intensity of the point from the maximum light intensity of the corresponding line; determining a lower deviation of the light intensity of the point from the minimum light intensity of the corresponding line; determining a minimum from the upper deviation and the lower deviation; assigning the minimum to the point; calculating a relative error in the selected column for multiple scanning times; and selecting the scanning time with the smallest relative error, in which the suitable line scanning frequency is the reciprocal of the selected scanning time. A system for transmitting light includes a transmitter and a receiver and is operable and/or adapted to perform the method.

### FIELD OF THE INVENTION

The present invention relates to a method for determining a suitable line scanning frequency of a receiver, e.g., when receiving a light signal sent out by a transmitter, in which the transmitter transmits the light signal at an approximately constant switching frequency, and the receiver captures images of the light signal at a constant line fundamental frequency. The present invention also relates to a system for transmitting light, e.g., which is operable using the method described herein.

### BACKGROUND INFORMATION

A system and a method for data transfer via visible light are described in German Patent Document No. 10 2018 006 988. The system has a receiver with an image sensor whose light-sensitive surface is scanned line by line, and a transmitter with a controllable illuminant which emits modulated light.

The receiver has a lenticular film or a cylindrical lens array, which is arranged between a lens of the receiver and the transmitter. An image projected onto the light-sensitive surface of the image sensor is displayed blurred. An increased data transfer rate is achieved by utilizing the rolling shutter effect of the image sensor.

A system for light transmission and a method for operating the system are also described in German Patent Document No. 10 2021 001 049. A point-shaped light source sends a beam of light onto profiled regions of a film, and the light beam is displayed in the form of a luminous strip. By line by line scanning of the receiver, a data stream can be detected from the luminous strip.

A system for light transmission and a method for operating the system are also described in German Patent Document No. 10 2019 007 311.

A system and a method for data transmission using light signals are described in U.S. Patent Application Publication No. 2015/0195042. Light is transmitted from a transmitter, which has multiple LEDs, to a receiver, which has multiple sensors.

A wireless information communication method of transmitting a signal using a luminance change of visible light is described in European Patent Document No. 2 940 902.

### SUMMARY

Example embodiments of the present invention provide a method for determining a suitable line scanning frequency of a receiver when receiving a light signal sent out by a transmitter, and a system for transmitting light being operable using the method described herein.

According to example embodiments, in a method for determining a suitable line scanning frequency of a receiver when receiving a light signal sent out by a transmitter, the transmitter transmits the light signal at an approximately constant switching frequency. The receiver captures images of the light signal at a constant line fundamental frequency, and two adjacent lines of an image are captured one after the other by a fundamental scanning time. The fundamental scanning time is the reciprocal of the line fundamental frequency.

The method includes: capturing an image number of images of the light signal at the line fundamental frequency, in which each of the captured images has an equal column number of columns and an equal line number of lines; selecting a column from each of the captured images; assembling the selected columns in order to form a matrix that has the image number of columns and the line number of lines; determining a point of maximum light intensity in each line of the matrix; determining a point of minimum light intensity in each line of the matrix; selecting a column of the matrix, in which respectively two adjacent points in the column are offset from each other by the fundamental scanning time; for each point of the selected column: determining an upper deviation of the light intensity of the point from the maximum light intensity of the corresponding line; determining a lower deviation of the light intensity of the point from the minimum light intensity of the corresponding line; determining a minimum from the upper deviation and the lower deviation; and assigning the minimum to the point; calculating a relative error in the selected column for multiple scanning times; in which each scanning time is an integer multiple of the fundamental scanning time; in which a starting point is selected in the selected column; and the relative error is calculated as the average of the minima assigned to the starting point and all points offset from the starting point by an integer multiple of the fundamental scanning time; selecting the scanning time with the smallest relative error, in which the suitable line scanning frequency is the reciprocal of the selected scanning time.

The line fundamental frequency of the receiver is usually significantly higher than the switching frequency of the transmitter. The receiver thus captures redundant data. For example, the receiver captures images at a line scanning frequency that corresponds to the switching frequency of the transmitter. The suitable line scanning frequency determined by the method corresponds at least approximately to the switching frequency of the transmitter.

The switching frequency of the transmitter is not known to the receiver exactly, but only approximately. According to example embodiments, the line fundamental frequency is higher than the switching frequency. For example, the line fundamental frequency is at least twice as high as the switching frequency. For example, the line fundamental frequency is at least four times as high as the switching frequency.

For example, the switching frequency is around 5 kHz. The line fundamental frequency of the receiver is 45 kHz, for example, and, in this case, is nine times as high as the switching frequency. The fundamental scanning time is the reciprocal of the line fundamental frequency and is, for example, 1/45,000 sec. The line number is 1,080, for example. For example, the integer multiple of the fundamental scanning time by which the points are offset from the starting point is a number between 6 and 12.

According to example embodiments: selecting a column of the matrix (M); for each point of the selected column: determining an upper deviation of the light intensity of the point from the maximum light intensity of the corresponding line; determining a lower deviation of the light intensity of the point from the minimum light intensity of the corresponding line; determining a minimum from the upper deviation and the lower deviation; and assigning the minimum to the point; and calculating a relative error in the selected column for multiple scanning times; in which each scanning time is an integer multiple of the fundamental scanning time; and in which the relative error is calculated as the average of the minima assigned to a starting point and all points offset from the starting point by an integer multiple of the scanning time; are repeated for each column of the matrix.

If various suitable line scanning frequencies are determined into different columns, the line scanning frequency that was determined most frequently is selected, for example.

According to example embodiments, the method additionally includes: selecting a column of the matrix; calculating a relative error in the selected column for multiple starting points; in which the relative error is calculated as the average of the minima assigned to the respective starting point and all points offset from the starting point by an integer multiple of the selected scanning time; and selecting the starting point with the smallest relative error.

This is used to determine the optimum phase position.

According to example embodiments: calculating a relative error in the selected column for multiple starting points; in which the relative error is calculated as the average of the minima assigned to the respective starting point and all points offset from the starting point by an integer multiple of the selected scanning time; and selecting the starting point with the smallest relative error; are repeated for each column of the matrix.

This is used to determine the optimum phase position for each column of the matrix and thus for each of the captured images.

This is used to determine the optimum phase position for each column of the matrix.

According to example embodiments, the receiver includes a camera which has an image sensor, a light-sensitive surface of the image sensor includes the line number of lines with light-sensitive elements, the light-sensitive surface of the image sensor is scanned line by line at the line fundamental frequency, and an attachment element which is arranged in the form of a film and which is arranged such that light incident on the light-sensitive surface of the image sensor first passes through the attachment element.

According to example embodiments, the attachment element has at least one lenticular region, and the lenticular region has an alternating material thickness.

According to example embodiments, the attachment element has a plurality of strip-shaped lenticular regions and a plurality of strip-shaped planar regions. The the lenticular regions have an alternating material thickness, and the planar regions have a constant material thickness.

According to example embodiments, the lenticular regions have recesses and a lower material thickness than the planar regions.

According to example embodiments, the lenticular regions have elevations and a greater material thickness than the planar regions.

A system for transmitting light includes a transmitter having at least one controllable light source which emits a light signal modulated according to a predetermined data stream, and a receiver for receiving the light signal sent out by the transmitter. The system is operable using the method described herein. For example, the system is operated using the method described herein.

The light source emits a light signal modulated according to a predetermined data stream at a constant carrier frequency of, for example, 5 kHz. Due to the modulation, the switching frequency deviates slightly from the constant carrier frequency of, for example, 5 kHz. The transmitter thus sends out a light signal at an approximately constant switching frequency.

Further features and aspects of example embodiments of the present invention are explained in more detail with reference to the appended schematic Figures.

### BRIEF DESCRIPTION OF THE DRAWINGS

FIG. 1 schematically illustrates a system for transmitting light.

FIG. 2 schematically illustrates a matrix.

### DETAILED DESCRIPTION

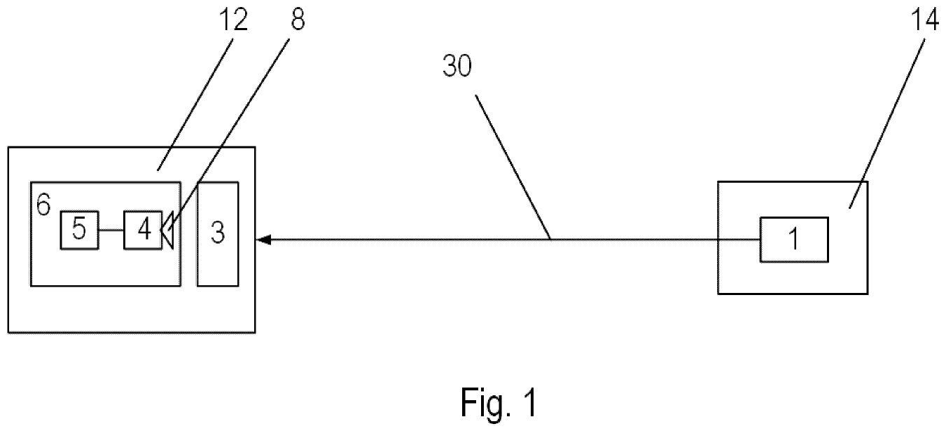

FIG. 1 schematically illustrates a system for transmitting light. The system for transmitting light includes a transmitter 14, which has a controllable light source 1. The light source 1 is, for example, an LED, a ceiling lamp, or a headlight of a vehicle.

The light source 1 emits a light signal 30 modulated according to a predetermined data stream with an approximately constant switching frequency of, for example, 5 kHz. Due to the modulation, the switching frequency deviates slightly from the constant carrier frequency of, for example, 5 kHz. The transmitter 14 thus sends out a light signal at the switching frequency.

The system for transmitting light further includes a receiver 12. The receiver 12 includes a camera 6. The camera 6 has an image sensor 4. The image sensor 4 has a light-sensitive surface including a line number K of lines and a column number J of columns of light-sensitive elements. During operation of the camera 6, the light-sensitive surface of the image sensor 4 is scanned line by line at a line fundamental frequency. The line fundamental frequency of the receiver 12 is 45 kHz, for example, and, in this case, is nine times as high as the switching frequency of the transmitter. The individual scanned lines are combined to form an image.

The camera 6 also includes an optical element in the form of an optical lens 8. The lens 8 is arranged in front of the image sensor 4 so that light incident on the light-sensitive surface of the image sensor 4 first passes through the lens 8. The camera 6 also includes signal electronics 5, which is used, for example, to scan the light-sensitive surface of the image sensor 4.

The receiver 12 also includes an attachment element 3. The attachment element 3 is arranged in front of the image sensor 4 such that light incident on the light-sensitive surface of the image sensor 4 first passes through the attachment element 3. The attachment element 3 is arranged in the form of a relatively thin, translucent film. The attachment element 3 is arranged between the light source 1 of the transmitter 14 and the camera 6.

The camera 6 of the receiver 12 is part of a commercially available cell phone or smartphone, for example. The receiver 12 optionally also includes a holding unit. The holding unit is, for example, a case that has a first holding element and a second holding element. The second holding element can be moved relative to the first holding element, e.g., pivoted. The cell phone with the camera 6 is held in the first holding element, and the attachment element 3 is held in the second holding element. This means that the attachment element 3 can be moved relative to the camera 6, for example, swiveled or displaced. If no data transmission via the system 10 is desired, the attachment element 3 can be removed from the camera 6 and the camera can capture a complete optical image without the attachment element 3.

The attachment element 3 has a plurality of strip-shaped lenticular regions and a plurality of strip-shaped planar regions. The strip-shaped lenticular regions and planar regions are oriented parallel to each other.

The planar regions of the attachment element 3 are configured such that light passing through the planar regions passes through the attachment element 3 at least approximately in a straight line, i.e., is not refracted or is only refracted to a negligible extent. The planar regions of the attachment element 3 have an at least approximately constant material thickness. Light that passes through the planar regions of the attachment element 3 generates a second image on the light-sensitive surface of the image sensor 4. The second image is a sharp optical image.

The lenticular regions of the attachment element 3 are configured such that light passing through the lenticular regions is refracted relatively strongly. For example, a light beam originating from the point-shaped light source 1 is depicted in the form of a luminous strip. Light that passes through the lenticular regions of the attachment element 3 generates a first image on the light-sensitive surface of the image sensor 4. The first image is blurred due to the relatively strong refraction of the light.

The lenticular regions of the attachment element 3 have an alternating material thickness. For example, the lenticular regions have concave recesses and thus a lower material thickness than the planar regions. For example, the lenticular regions have convex elevations and thus a greater material thickness than the planar regions. The elevations or recesses of the lenticular regions have, for example, a respectively approximately semi-circular cross-section. Light incident on the lenticular regions is thus refracted to different degrees depending on the point of incidence.

When the method is carried out, the transmitter 14 sends out a light signal 30 with the approximately constant switching frequency. The receiver 12 captures an image number N of images of the light signal 30 at the constant line fundamental frequency. Each of the captured images has the same column number J of columns and the same line number K of lines. Two adjacent lines of an image are captured one after the other by a fundamental scanning time. The fundamental scanning time is the reciprocal of the line fundamental frequency.

One of the columns is selected from each of the captured images. For example, the column is selected which most clearly shows the luminous strip generated by the point light source 1 via the attachment element 3. For example, the luminous strip in each of the images is shown most clearly in the same column. Thus, the same column is selected in every image.

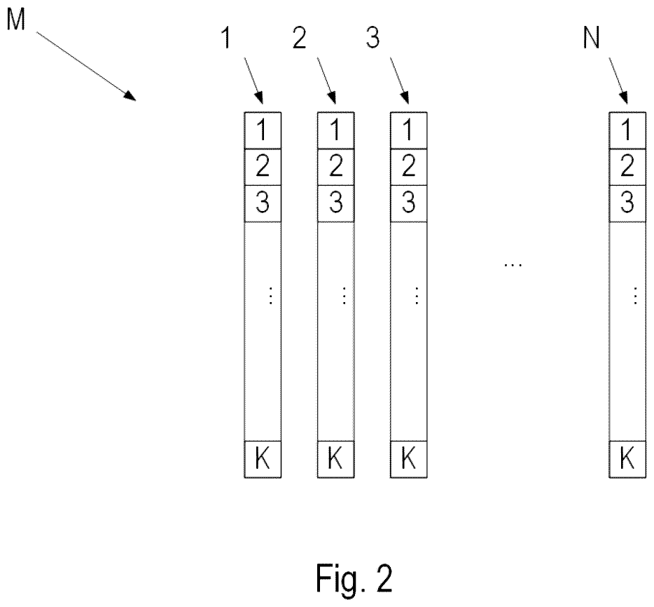

The selected columns of the images are combined to form a matrix M. FIG. 2 schematically illustrates such a matrix M. The matrix M has the image number N of columns and the line number K of lines. Each line of the matrix M thus has the image number N of points. Each column of the matrix M thus has the line number K of points. In each column of the matrix M, respectively two adjacent points are offset from each other by the fundamental scanning time. Each of the points of the matrix M has a light intensity.

In each line of the matrix M, that point is determined which has a maximum light intensity Dmax in the line. Also, in each line of the matrix M, that point is determined which has a minimum light intensity Dmin in the line.

Any column of the matrix M is selected, for example, the first column. For each point of the selected column, an upper deviation of the light intensity of the point from the maximum light intensity Dmax of the corresponding line is determined. For each point of the selected column, a lower deviation of the light intensity of the point from the minimum light intensity Dmin of the corresponding line is also determined. Subsequently, for each point of the selected column, a minimum is determined from the upper deviation and the lower deviation. The minimum is assigned to the point.

The deviation of the light intensity of the point from the maximum light intensity Dmax is calculated, for example, as the amount of the difference between the light intensity of the point and the maximum light intensity Dmax. Alternatively, the deviation of the light intensity of the point from the maximum light intensity Dmax is calculated, for example, as the square of the difference between the light intensity of the point and the maximum light intensity Dmax.

The deviation of the light intensity of the point from the minimum light intensity Dmin is calculated, for example, as the amount of the difference between the light intensity of the point and the minimum light intensity Dmin. Alternatively, the deviation of the light intensity of the point from the minimum light intensity Dmin is calculated, for example, as the square of the difference between the light intensity of the point and the minimum light intensity Dmin.

Subsequently, in the selected column, a relative error is respectively calculated for several scanning times. Each scanning time is an integer multiple of the fundamental scanning time. For this, a starting point is selected in the selected column. For example, the starting point is the first point in the column.

The relative error of a scanning time is calculated as the average of the minima assigned to the starting point and all points offset from the starting point by an integer multiple of the fundamental scanning time. The integer multiple of the fundamental scanning time by which the points are offset from the starting point is, for example, numbers between 6 and 12. For example, the starting point and every sixth subsequent point are taken into account when calculating the average of the minima. The points in between are not taken into account.

The calculated relative errors of the scanning times are compared with each other. The scanning time having the lowest relative error is selected. The suitable line scanning frequency is thus the reciprocal of the selected scanning time. Thus, the suitable line scanning frequency of the receiver 12 when receiving a light signal 30 sent out by a transmitter 14 is determined.

As described above, any column of the matrix M, for example, the first column, is selected for determining the suitable line scanning frequency. It is possible that the steps described above for determining the suitable line scanning frequency are repeated for several columns of the matrix M, for example, for all columns of the matrix M. If various suitable line scanning frequencies are determined into different columns, the line scanning frequency that was determined most frequently is selected, for example.

After determining the suitable line scanning frequency, the optimum phase position within a column is also determined. A column of the matrix M is selected for this purpose. In the selected column, a relative error is respectively calculated for several starting points. The relative error is calculated as the average of the minima assigned to the respective starting point and all points offset from the starting point by an integer multiple of the selected scanning time. The starting point with the lowest relative error is selected.

The optimum phase position is, for example, determined in each column. For this, the above steps are repeated for each column of the matrix M.

### LIST OF REFERENCE CHARACTERS

1 Light source
3 Attachment element
4 Image sensor
5 Signal electronics
6 Camera
8 Lens
12 Receiver
14 Transmitter
30 Light signal
M Matrix
N Image number
J Column number
K Line number
Dmax Maximum light intensity
Dmin Minimum light intensity

1-11. (canceled).

12. A method for determining a suitable line scanning frequency of a receiver during receiving of a light signal transmitted by a transmitter; comprising:
transmitting, by the transmitter, the light signal at an approximately constant switching frequency;
capturing, by the receiver, images of the light signal at a constant line fundamental frequency, two adjacent lines of an image being captured one after another by a fundamental scanning time that is a reciprocal of the line fundamental frequency;
capturing an image number of images of the light signal at the line fundamental frequency, each of the captured images having an equal column number of columns and an equal line number of lines;
selecting a column from each of the captured images;
assembling the selected columns to form a matrix having the image number of columns and the line number of lines;
determining a point of maximum light intensity in each line of the matrix;
determining a point of minimum light intensity in each line of the matrix;
selecting a column of the matrix, in which respectively two adjacent points in the column are offset from each other by the fundamental scanning time;
for each point of the selected column:
determining an upper deviation of light intensity of the point from the maximum light intensity of the corresponding line;
determining a lower deviation of the light intensity of the point from the minimum light intensity of the corresponding line;
determining a minimum from the upper deviation and the lower deviation; and
assigning the minimum to the point;
calculating a relative error in the selected column for multiple scanning times, each scanning time being an integer multiple of the fundamental scanning time;
selecting a starting point in the selected column;
calculating the relative error as an average of the minima assigned to a starting point and all points offset from the starting point by an integer multiple of the scanning time; and
selecting the scanning time with a smallest relative error, the suitable line scanning frequency being a reciprocal of the selected scanning time.

13. The method according to claim 12, wherein the line fundamental frequency is higher than the switching frequency.

14. The method according to claim 12, wherein the line fundamental frequency is at least twice as high as the switching frequency.

15. The method according to claim 12, wherein the line fundamental frequency is at least four times as high as the switching frequency.

16. The method according to claim 12, wherein the selecting of a column of the matrix, the determining of the upper deviation of the light intensity of the point from the maximum light intensity of the corresponding line, the determining of the lower deviation of the light intensity of the point from the minimum light intensity of the corresponding line, the determining of the minimum from the upper deviation and the lower deviation, the assigning of the minimum to the point, the calculating of the relative error in the selected column for multiple scanning times, and the calculating of the relative error as the average of the minima assigned to a starting point and all points offset from the starting point by the integer multiple of the scanning time are repeated for each column of the matrix.

17. The method according to claim 12, wherein further comprising:
selecting a column of the matrix;
calculating a relative error in the selected column for multiple starting points as an average of the minima assigned to the respective starting point and all points offset from the starting point by an integer multiple of the selected scanning time; and
selecting the starting point with a smallest relative error.

18. The method according to claim 17, wherein the calculating of the relative error in the selected column for multiple starting points as the average of the minima assigned to the respective starting point and all points offset from the starting point by the integer multiple of the selected scanning time and the selecting of the starting point with the smallest relative error are repeated for each column of the matrix.

19. The method according to claim 12, wherein the receiver includes a camera having an image sensor and an attachment element, a light-sensitive surface of the image sensor including the line number of lines with light-sensitive elements, the light-sensitive surface of the image sensor being scanned line by line at the line fundamental frequency, the attachment element including a film and being arranged such that light incident on the light-sensitive surface of the image sensor first passes through the attachment element.

20. The method according to claim 19, wherein the attachment element includes at least one lenticular region having an alternating material thickness.

21. The method according to claim 19, wherein the attachment element includes a plurality of strip-shaped lenticular regions and a plurality of strip-shaped planar regions, the lenticular regions having an alternating material thickness, the planar regions having a constant material thickness.

22. The method according to claim 21, wherein the lenticular regions have recesses and a lower material thickness than the planar regions.

23. The method according to claim 21, wherein the lenticular regions have elevations and a greater material thickness than the planar regions.

24. The method according to claim 19, wherein the attachment element is arranged between a light source of the transmitter and the camera.

25. The method according to claim 19, wherein the camera is arranged as a component of a mobile phone.

26. The method according to claim 19, wherein the attachment element is movable relative to the camera.

27. The method according to claim 19, wherein the attachment element is removable from the camera.

28. The method according to claim 19, wherein the receiver including a holding unit having a first holding part and a second holding part, the first holding part holding the camera, the second holding part holding the attachment element, the first and second holding part being movable relative to each other so that the camera and the attachment element are movable relative to each other.

29. The method according to claim 21, wherein the strip-shaped lenticular regions and the strip-shaped planar regions are parallel to each other.

30. The method according to claim 21, wherein the strip-shaped lenticular regions are adapted to pass light with diffraction and the strip-shaped planar regions are adapted to pass light without diffraction.

31. A system for transmitting light, comprising:
a transmitter including at least one controllable light source adapted to emit a light signal modulated according to a predetermined data stream; and
a receiver adapted to receive the light signal emitted by the transmitter;
wherein the system is adapted to perform the method recited in claim 12.
